(19) United States
(12) Patent Application Publication
(10) Pub. No.: US 2005/0220005 A1
(43) Pub. Date: Oct. 6, 2005

(54) Method and device for communication with a redundant system

(76) Inventor: Dominique Bornant, Chatillc (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/510,130

(22) PCT Filed: Apr. 4, 2003
(86) PCT No.: PCT/FR03/01079

§ 371 Date: Oct. 4, 2004

(30) Foreign Application Priority Data
Apr. 5, 2002 (FR) 02/0463

(51) Int. Cl. H04J 15/00

(52) U.S. Cl. 370/215

(57) ABSTRACT

The invention relates to a process and a device for communication with a redundant system. A redundant system is a system comprising duplicate physical entities, forming groups of redundant physical entities. These physical entities may be routers or communication lines. In each group of redundant physical entities, a physical entity is active, the other entity or entities are inactive. Means for managing the redundancy controlling the switching of said physical entities is from an active to an inactive state. The invention applies in respect of the processing of air traffic management information. It applies I respect to any system for routing complex digital data requiring highly dependable operation.

The invention relates to a process and device for communication with a redundant system. It applies in particular in respect of the processing of air traffic management information. More generally, it applies in respect of any system for routing complex digital data requiring highly dependable operation.

The density of air traffic has reached a very significant level. Moreover, air safety requirements are continuing to be ever more demanding. A consequence of this situation is that the management of air traffic has to process a great deal of information, intended in particular for air traffic controllers and aircraft pilots. This information relates in particular to a wide category of radar data, to meteorological situations, to flight plans or else to data of ILS type relating to landing systems.

An air traffic control center generally comprises interfacing means, also called routers, one main function of which is the steering of the data to the right destination center. These routers may be linked to workstations of the air traffic controllers by way of a local area network, such as Ethernet. These routers may be linked on the other hand to processing circuits by data transmission lines, such as serial lines.

The dependability of operation of computer systems is of the foremost importance, since the safety of the passengers is at stake. By way of example, the safety standards in force require that the aerial coverage of an air traffic control center must not be interrupted for more than a few seconds per year. It is therefore necessary to resort to redundancy techniques, that is to say in particular to duplicate the physical equipment of the control center, such as the routers and the communication lines.

A redundant system is a system comprising duplicate physical entities, forming groups of redundant physical entities. In each group of redundant physical entities, a physical entity is active, the other entity or entities are inactive. Means of managing the redundancy control the switching of said physical entities from an active to an inactive state and vice versa. When an active entity becomes defective, one of the inactive entities takes over and becomes the active entity. In practice, the activation and inactivation control function is carried out by redundancy management means. These management means may be in a third-party system or distributed among the redundant physical entities. Document FR 2 808 353 describes distributed management means.

Vis-à-vis applications which communicate with a redundant system or by way of such a system, it is necessary to know which ones are the active entities. Specifically, the information has to be forwarded to the active entities directly, the inactive entities being nonoperational. In particular when an active entity becomes defective, the application which was communicating with the latter or by way of the latter must communicate with or by way of the entity which takes over (the new active entity). The forwarding of the data is thereby modified.

Such applications must monitor the redundant system, and in particular:
when they start up, ascertain which of them are the active entities;
when an active entity becomes defective, ascertain which one is the new active entity.

An aim of the invention is to simplify the operation of such applications, communicating with or by way of a redundant system.

For this purpose, a subject of the invention is in particular a process for communication with a redundant system, said system comprising at least one group of redundant physical entities, a physical entity of said group being an active entity, the other physical entity or entities of said group being inactive entities, means for managing the redundancy controlling the switching of said physical entities from an active to an inactive state and vice versa, characterized in that:
each physical entity is allocated a physical identifier;
each group of physical entities is allocated a logical identifier;
the management means are communicated with in order to determine the active physical entities;
the physical identifier of the active entity is associated with each logical identifier;
the messages of an application are transmitted to the redundant system, substituting each logical identifier with the associated physical identifier;
the messages of the redundant system are transmitted to the application, substituting each physical identifier with the associated logical identifier.

According to an advantageous mode of implementation, the associations between logical identifier and physical identifier are stored in a correspondence table.

A subject of the invention is also a device for communication with a redundant system, said system comprising at least one group of redundant physical entities, a physical entity of said group being an active entity, the other physical entity or entities of said group being inactive entities, means for managing the redundancy controlling the switching of said physical entities from an active to an inactive state and vice versa, characterized in that it comprises a server application and at least one client application communicating together, in which the server application:
allocates a physical identifier to each physical entity;
allocates a logical identifier to each group of physical entities;
communicates with the management means in order to determine the active physical entities;
associates the physical identifier of the active entity with each logical identifier;
transmits the messages of the client application to the redundant system, substituting each logical identifier with the associated physical identifier;
transmits the messages of the redundant system to the client application, substituting each physical identifier with the associated logical identifier.

According to an advantageous embodiment, the server application communicates with several client applications of one and the same workstation.

According to an advantageous embodiment, the server application operates continuously.

Other characteristics and advantages of the invention will become apparent with the aid of the description which follows in conjunction with the appended drawings which represent:

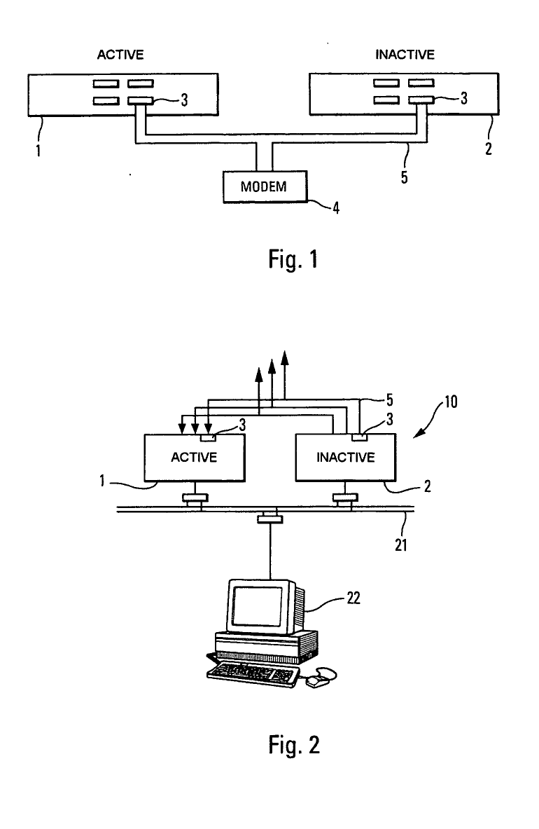

FIG. 1, an exemplary redundant system;

FIG. 2, an exemplary redundant system linked to a workstation by way of a local area network of Ethernet type;

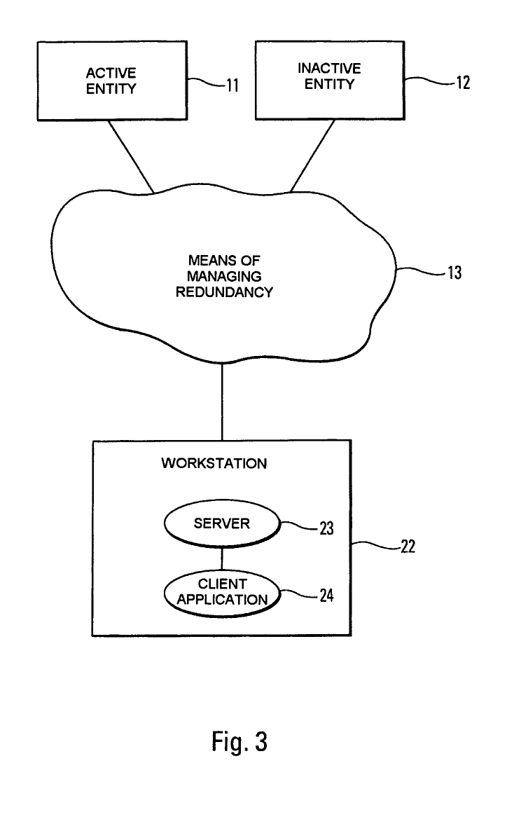

FIG. 3, an exemplary software architecture according to the invention which allows an application of a workstation, the workstation being linked to a redundant system, to communicate with the redundant system;

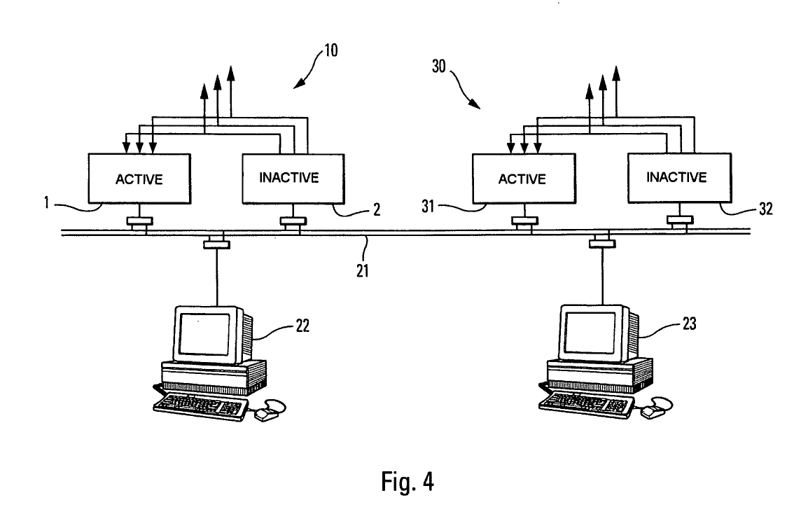

FIG. 4, an exemplary redundant system comprising several groups of duplicate physical entities, and which is linked to several workstations by way of a local area network of Ethernet type.

FIG. 1 presents an exemplary redundant routing system. It comprises for example two routers 1, 2 having the same functions and comprising in particular the same software and same configuration files. One and the same port 3 of each router communicates through a serial link with one and the same system 4, for example a modem. For this purpose, the link between the latter and the two routers is effected by a y cable 5. When the two routers start up together, a router 1 is active and the other 2 is inactive. The active router 1 activates its electrical modes on its input/output ports 3, while the inactive router 2 leaves its ports 3 inactivated, that is to say in the high impedance state. Means of managing the redundancy control the switching of the redundant group of routers 1, 2 from an active to an inactive state and vice versa.

These routers 1, 2 may be known hardware and in particular are available commercially. By way of example mention may be made of a range of products known by the acronym LINES stemming from the expression “Link Interface Node for External Systems”. These products, of modular type, are designed to allow the routing and the processing of input/output messages among incoming or outgoing serial lines and an Ethernet. The standard serial liens such as for example X25, HDLC or BSC are processed as well as dedicated lines, such as for example particular protocols for transmitting radar information.

These routers 1, 2 may operate according to an open mode of communication, also termed OCP standing for “Open Communication Processor”. In this mode, a router is networked, that is to say linked to several applications. It operates substantially as a data server. In particular it makes it possible to steer and to process the data from any input point to any output point. This mode of operation is particularly well suited to the management of air traffic. In an air traffic control management application, this mode in fact allows in particular the following functionalities:
black box type distribution of the radar data to the centers, the radar data being received by serial interfaces and transmitted via a local network, for example Ethernet, to a group of identified machines, broadcast called “multicast” in the literature (UDP or TCP);
autonomous conversion of messages or protocols, allowing in particular the format conversion of messages or specific protocols, as well as for example ISR2 or ASTERIX, X25, HDLC-UI etc.;
a line control function in the radar system, that is to say the transmission of radar data through serial lines to the processing circuits.

FIG. 2 illustrates an exemplary redundant system 10 linked to a workstation 22 by way of a local area network 21, called a LAN in the literature, for example Ethernet. The workstation 22 comprises a client application which communicates with the redundant system.

The redundant system 10 can comprise two routers 1, 2, such as those described in conjunction with FIG. 1. The two routers comprise the same functions, and in particular the same software and the same configuration files. The inputs and outputs to other systems are redundant.

The two routers 1,2 are for example linked to other systems via serial links. These other system may be modems. A y cable 5 links one and the same port 3 of each router to one and the same system, in such a way in particular that these two ports 3 can exchange with this system. The active router 1 has its serial port activated, the inactive router 2 has its serial port inactivated, being for example in the high impedance state.

Advantageously, the routers 1, 2 are linked to one another by two interfaces, the local area network 21 and a safety line (not represented), and exchange interrogation messages mutually via these two interfaces, a router being considered to be defective by the other router when it does not send any message in a given time interval over at least one of the two interfaces. Consequently, the redundancy management means are distributed between the two routers 1, 2.

FIG. 3 illustrates an exemplary software architecture according to the invention which allows an application 24 of a workstation 22, the workstation being linked to a redundant system, to communicate with the redundant system.

The redundant system may be that described in conjunction with FIG. 2. It comprises means of managing redundancy 13. The application 24 communicates with an active entity 11. This entity 11 forms an integral part of the redundant system. This entity can be a router or a serial line for example. This entity is redundant. Stated otherwise, there exists at least one inactive entity 12 which may be activated so as to substitute itself for the initial active entity 11.

The means of managing redundancy 13 determine when an entity becomes active or inactive, and control the switching from an active to an inactive state and vice versa.

The application 24 of the workstation 22 can operate according to a client server mode. Stated otherwise, the application 24 is a client application which sends requests to a server application 23. For this purpose the client application 24 uses functions of an application package interface, called API in the literature standing for the expression “Application Programming Interface”.

The server application 23 communicates with the means for managing redundancy 13. As soon as it is started up, the server application listens for supervisory messages. The supervisory messages are sent by the means for managing redundancy 13. These messages make it possible to determine which entity of a group of redundant physical entities 11, 12 is active. Stated otherwise, the server application 23 supervisors the means for managing redundancy.

The server application 23 allocates a unique identifier, called the physical identifier, to each physical entity. It furthermore allocates a unique identifier, called the logical identifier, to each group of redundant physical entities. It associates the physical identifier of the active entity with each logical identifier. This association can be stored in a correspondence table.

For example, the redundant entity group can have a logical identifier “A”, the active entity 11 the physical identifier “A1”, the inactive entity 2 the physical identifier “A2”. The association “A corresponds to A1” is stored in the correspondence table.

When the client application 24 sends data to the redundant system:
the client application dispatches a message while giving the logical identifier “A” to a function of the API of the server application;
the server application receives this message;
the server application looks through its correspondence table and substitutes the identifier “A” with the associated physical identifier “A1”;
the server application forwards this message to the active entity 11, that is to say the one identified by “A1”.

When the client application 24 receives data from the redundant system:
a message is sent by the active entity 11 over an active link;
the server application receives this message and ascertains the identifier “A1” of the sender;
the server application looks through its correspondence table and substitutes the physical identifier “A1” with the associated logical identifier “A”;
the server application transmits the message to the application while indicating thereto the logical identifier “A” of the sender.

Consequently, if the inactive entity 12 becomes the new active entity, the client application 24 will send and receive the same messages as if the active entity had remained the same. Stated otherwise, the client application 24 uses just one logical identifier whatever the destination. The server application 23 plays the role of a communication interface between the redundant system and the client application. This interface renders the redundancy of the system totally transparent vis-à-vis the application. It is not necessary to supervise all of the physical entities of the redundant system each time the client application is started up, since this function is carried out by the server application. This simplifies the programming and the manner of operation of the client applications, and reduces the risk of routing error.

Advantageously, a single server application 23 may communicate with several client applications 24 of one and the same workstation. The server application can operate continuously so as to update the correspondence table.

FIG. 4 illustrates an exemplary redundant system comprising several groups 10, 30 of duplicate physical entities, and which is linked to several workstations 22, 23 by way of a local area network of Ethernet type.

The principles set forth apply directly. The correspondence table comprises two logical identifiers, that is to say one logical identifier per group. A physical identifier is associated with each physical entity (active or otherwise) 1, 2, 31, 32.

There may be a server application on each workstation 22, 23. Thus, the client applications of these workstations can communicate with any active physical entity of the redundant system.

1. A process for communication with a redundant system, said system comprising at least one group (10) of redundant physical entities (1, 2), a physical entity (1) of said group being an active entity, the other physical entity or entities (2) of said group being inactive entities, means for managing the redundancy (13) controlling the switching of said physical entities from an active to an inactive state and vice versa, characterized in that:
each physical entity is allocated a physical identifier;
each group of physical entities is allocated a logical identifier;
the management means are communicated with in order to determine the active physical entities;
the physical identifier of the active entity is associated with each logical identifier;
the messages of an application are transmitted to the redundant system, substituting each logical identifier with the associated physical identifier;
the messages of the redundant system are transmitted to the application, substituting each physical identifier with the associated logical identifier.

2. The communication process as claimed in claim 1, characterized in that the associations between logical identifier and physical identifier are stored in a correspondence table.

3. The communication process as claimed in any one of the preceding claims, characterized in that the physical entities are routers.

4. The communication process as claimed in any one of claims 1 to 3, characterized in that the physical entities are serial lines.

5. A device for communication with a redundant system, said system comprising at least one group (10) of redundant physical entities (1, 2), a physical entity (1) of said group being an active entity, the other physical entity or entities (2) of said group being inactive entities, means for managing the redundancy (13) controlling the switching of said physical entities from an active to an inactive state and vice versa, characterized in that it comprises a server application (23) and at least one client application (24) communicating together, in which the server application:
allocates a physical identifier to each physical entity;
allocates a logical identifier to each group of physical entities;
communicates with the management means in order to determine the active physical entities;
associates the physical identifier of the active entity with each logical identifier;
transmits the messages of the client application to the redundant system, substituting each logical identifier with the associated physical identifier;
transmits the messages of the redundant system to the client application, substituting each physical identifier with the associated logical identifier.

6. The device for communication as claimed in the preceding claim, characterized in that the server application (23) communicates with several client applications (24) of one and the same workstation (22).

7. The device for communication as claimed in any one of claims 5 to 6, characterized in that the server application operates continuously.

8. The device for communication as claimed in any one of claims 5 to 7, characterized in that the physical entities are routers.

9. The device for communication as claimed in any one of claims 5 to 8, characterized in that the physical entities are serial lines.
